(19) United States
(12) Patent Application Publication
(10) Pub. No.: US 2013/0270894 A1
(43) Pub. Date: Oct. 17, 2013

(54) INITIAL FLOW INCREASING MODULE FOR REDUCING DELAY OF BRAKE RESPONSE

(71) Applicants: Hee Jun Kim, Seoul (KR); I Jin Yang, Seongnam-si (KR)

(72) Inventors: Hee Jun Kim, Seoul (KR); I Jin Yang, Seongnam-si (KR)

(21) Appl. No.: 13/862,085

(22) Filed: Apr. 12, 2013

(30) Foreign Application Priority Data
Apr. 13, 2012 (KR) 10-2012-0038206

(51) Int. Cl. B60T 13/14

(52) U.S. Cl. CPC B60T 13/142
USPC 303/6.01

(57) ABSTRACT

There is provided an initial flow increasing module. The initial flow increasing module is connected with an electronic stability control (ESC) system having a first hydraulic channel and a second hydraulic channel each for controlling a liquid pressure transmitted to two wheels, and includes a hydraulic circuit that includes a pressure source in which oil is stored so as to increase a braking initial flow and a flow control valve connected with the pressure source so as to control a flow of oil transmitted to a wheel brake provided in each wheel from the pressure source.

### CROSS-REFERENCE TO RELATED APPLICATION

This application claims the benefit of Korean Patent Application No. 2012-0038206, filed on, Apr. 13, 2012 in the Korean Intellectual Property Office, the disclosure of which is incorporated herein by reference.

### BACKGROUND

1. Field

Embodiments of the present invention relate to a brake system, and more particularly, an initial flow increasing module that may improve a braking sense by reducing delay of brake responsiveness caused by abrasion of a brake pad.

2. Description of the Related Art

In general, in a vehicle, a hydraulic brake for reducing the speed of the vehicle and stopping the vehicle is provided. In this instance, an electro-hydraulic brake system which is a type of the hydraulic brakes is a brake system in which a braking oil pressure is generated by pressurizing oil supplied from a reservoir in a master cylinder when a brake pedal is pressed by a driver, and braking action is performed by transmitting the braking oil pressure to a wheel brake provided in each wheel.

In recent years, the electro-hydraulic brake system may have a function of an electronic stability control (ESC) system that independently controls a braking force of each wheel by controlling the braking oil pressure transmitted to the wheel brake provided in each wheel.

In addition, even though a braking pressure is not generated in the wheel brake that performs braking action by pressurizing both sides of a disk rotating together with the wheel when the braking oil pressure is transmitted, the disk and a brake pad pressurizing the disk are in contact with each other while traveling due to uneven abrasion and the like of the brake pad, whereby a residual frictional force is generated to cause acceleration and traveling loss.

In order to solve this problem, a well-known auto-adjuster mechanism is provided in the wheel brake so as to adjust an interval between the disk and the pad.

However, the residual frictional force can be removed by the auto-adjuster mechanism, but the interval between the disk and the brake pad becomes large due to the abrasion of the brake pad, whereby there is a problem that the response speed when braking is delayed.

### SUMMARY

Therefore, it is an aspect of the present invention to provide an initial flow increasing module that may improve a braking sense by reducing delay of brake response even though an interval between a disk and a brake pad becomes large due to abrasion of the brake pad.

Additional aspects of the invention will be set forth in part in the description which follows and, in part, will be obvious from the description, or may be learned by practice of the invention.

In accordance with one aspect of the present invention, an initial flow increasing module for reducing delay of brake responsiveness due to abrasion of a brake pad, which is connected with an electronic stability control (ESC) system having a first hydraulic channel and a second hydraulic channel each for controlling a liquid pressure transmitted to two wheels, the initial flow increasing module includes: a hydraulic circuit that includes a pressure source in which oil is stored so as to increase a braking initial flow and a flow control valve connected with the pressure source so as to control a flow of oil transmitted to a wheel brake provided in each wheel from the pressure source, wherein the hydraulic circuit includes a first hydraulic circuit connected with the first hydraulic channel and a second hydraulic circuit connected with the second hydraulic channel, and the first and second hydraulic circuits respectively include a first pressure source and a first flow control valve and a second pressure source and a second flow control valve and are operated independently.

Here, the ESC may include the first hydraulic channel connected with a first port of a master cylinder for generating a pressure so as to control liquid pressure transmission to the wheel brake and the second hydraulic channel connected with a second port of the master cylinder to control liquid pressure transmission to the wheel brake, the first and second hydraulic channels may respectively include a plurality of NO-type solenoid valves and a plurality of NC-type solenoid valves which are provided in an upstream side and a downstream side of the wheel brake so as to control a flow of a braking oil pressure, a low pressure accumulator for temporarily storing oil discharged from the wheel brake, a pump for sucking and pumping the oil discharged from the wheel brake or oil from the master cylinder by drive of a motor, a TC valve provided on a main flow passage for connecting the master cylinder and an outlet of the pump, a shuttle valve provided on an auxiliary flow passage branched from the main flow passage so as to guide oil of the master cylinder to be sucked into an inlet of the pump, and an electronic control unit for controlling drive of the plurality of solenoid valves and the motor, and the oil stored in each of the pressure sources of the first and second hydraulic circuits may be formed so as to store the oil discharged from the master cylinder or the oil discharged from the pump.

Also, when the oil discharged from the master cylinder is stored, the first hydraulic circuit may include a first oil suction flow passage connected so as to store the oil discharged from the master cylinder in the first pressure source and a first connection flow passage connected with the main flow passage so as to transmit the oil stored in the first pressure source to the wheel brake through the first flow control valve, and the second hydraulic circuit may include a second oil suction flow passage connected so as to store the oil discharged from the master cylinder in the second pressure source and a second connection flow passage connected with the main flow passage so as to transmit the oil stored in the second pressure source to the wheel brake through the second flow control valve.

In addition, a relief valve may be provided on each of the first and second oil suction flow passages.

In addition, the first and second flow control valves may be provided as a normally closed-type solenoid valve that remains normally closed and opened when braking action is performed in a case in which an interval between a disk and a brake pad which are provided in the wheel brake is increased.

In addition, when the oil discharged from the outlet of the pump is stored, the first hydraulic circuit may include a first connection flow passage connected with the first pressure source through the first flow control valve, and the second hydraulic circuit may include a second connection flow passage connected with the second pressure source through the second flow control valve.

Moreover, the first and second flow control valves may be provided as a two-way normally closed-type solenoid valve that remains normally closed and opened when oil is stored in the first and second pressure sources or remains normally closed and opened when braking action is performed in a case in which an interval between a disk and a brake pad which are provided in the wheel brake is increased.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a hydraulic circuit diagram showing an electro-hydraulic brake system including an initial flow increasing module according to a preferred embodiment of the present invention;

FIG. 2 is a hydraulic circuit diagram showing an electro-hydraulic brake system including an initial flow increasing module according to another preferred embodiment of the present invention; and

FIG. 3 is a hydraulic circuit diagram showing an operating state of an initial flow increasing module according to a preferred embodiment of the present invention.

### DETAILED DESCRIPTION

Example embodiments of the present invention are disclosed herein. However, specific structural and functional details disclosed herein are merely representative for purposes of describing example embodiments of the present invention. Example embodiments of the present invention may be embodied in many alternate forms and should not be construed as limited to example embodiments of the present invention set forth herein.

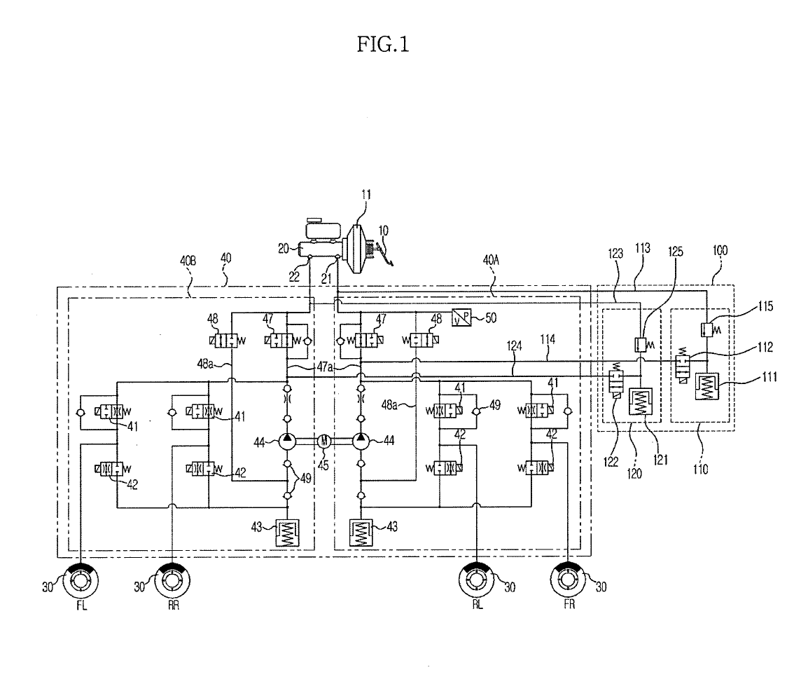

FIG. 1 is a hydraulic circuit diagram showing an electro-hydraulic brake system including an initial flow increasing module according to a preferred embodiment of the present invention. In the electro-hydraulic brake system according to the present embodiment, an example of an electronic stability control (hereinafter, referred to as “ESC”) system that may keep a traveling condition of a vehicle stable by controlling a braking liquid pressure in a combination with an anti-lock brake system (ABS) for preventing slippage of the wheel at the time of braking a vehicle and a traction control system (TCS) for preventing slippage of the wheel at the time of a sudden start or sudden acceleration of a vehicle is illustrated.

The ESC 40 is connected with a master cylinder 20 that generates a pressure by a brake booster 11 for doubling a tread force of a brake pedal 10 of a driver so as to control a braking oil pressure transmitted to a wheel brake 30 provided in each of wheels FL, FR, RL, and RR. More specifically, referring to FIG. 1, the ESC 40 includes a first hydraulic channel 40A for connecting a first port 21 of the master cylinder 20 and two wheel brakes 30 to control liquid pressure transmission, and a second hydraulic channel 40B for connecting a second port 22 of the master cylinder 20 and the remaining two wheel brakes 30 to control liquid pressure transmission. In this instance, the first hydraulic channel 40A and the second hydraulic channel 40B are provided in a hydraulic block (not shown) in a compact manner.

The first and second hydraulic channels 40A and 40B respectively include a plurality of solenoid valves 41 and 42 for controlling a braking oil pressure transmitted to two wheel brakes 30 side, a pump 44 for sucking and pumping oil discharged from the wheel brake 30 by drive of a motor 45 or oil from the master cylinder 20, a low pressure accumulator 43 for temporarily storing oil discharged from the wheel brake 30, a main flow passage 47a for connecting an outlet of the pump 44 and the master cylinder 20, an auxiliary flow passage 48a for guiding the oil of the master cylinder 20 to be sucked into an inlet of the pump 44, and an electronic control unit (not shown) for controlling drive of the plurality of solenoid valves 41 and 42 and the motor 45.

The plurality of solenoid valves 41 and 42 are in conjunction with upstream and downstream sides of the wheel brake 30, and are divided into a normally open-type (NO-type) solenoid valve 41 that is disposed on the upstream side of the wheel brake 30 and remains normally opened and a normally closed-type (NC-type) solenoid valve 42 that is disposed on the downstream side of the wheel brake 30 and remains normally closed. Opening and closing operations of the solenoid valves 41 and 42 may be controlled by the electronic control unit (not shown) for detecting the speed of a vehicle through a wheel speed sensor (not shown) disposed in each of the wheels FL, FR, RL, and RR, and the NC-type solenoid valve 42 is opened in accordance with pressure reducing braking, so that oil discharged from the wheel brake 30 side may be temporarily stored in the low pressure accumulator 43.

The pump 44 may be driven by the motor 45 so as to suck and discharge the oil stored in the low pressure accumulator 43, and therefore a liquid pressure is transmitted to the wheel brake 30 side or the master cylinder 20 side.

In addition, in the main flow passage 47a for connecting the master cylinder 20 and the outlet of the pump 44, a normally open-type TC valve 47 is provided. The TC valve 47 remains normally opened and allows a braking liquid pressure formed in the master cylinder 20 at the time of general braking through the brake pedal 10 to be transmitted to the wheel brake 30 side through the main flow passage 47a.

In addition, the auxiliary flow passage 48a is branched from the main flow passage 47a, and guides oil of the master cylinder 20 to be sucked into the inlet side of the pump 44. In the auxiliary flow passage 48a, a shuttle valve 48 for causing the oil to flow only to the inlet of the pump 44 is provided. The shuttle valve 48 that is electrically operated is provided in the middle of the auxiliary flow passage 48a so that the shuttle valve 48 is normally closed but opened in a TCS mode.

Meanwhile, a reference numeral “49” which is not described refers to a check valve that is provided in an appropriate position of the flow passage in order to prevent reverse flow of oil, and a reference numeral “50” refers to a pressure sensor that detects a braking pressure transmitted to the TC valve 47 and the shuttle valve 48.

The initial flow increasing module 100 is connected to the above-described ESC 40. The initial flow increasing module 100 is provided so as to improve brake responsiveness by increasing a flow of the oil transmitted to the wheel brake 30. That is, as described in the background of the invention, the initial flow increasing module 100 may be used to prevent the reduction in the brake responsiveness when an interval between a disk (not shown) and a brake pad (not shown) of the wheel brake 30 is increased due to abrasion of the brake pad. Therefore, the initial flow increasing module 100 according to an embodiment of the present invention includes pressure sources 111 and 121 in which oil is stored so as to increase a braking initial flow, and hydraulic circuits 110 and 120 having flow control valves 112 and 122 connected with the pressure sources 111 and 121 to control a flow of oil transmitted to the wheel brake 30 provided in each of the wheels FL, FR, RL, and RR from the pressure sources 111 and 121.

As shown in FIG. 1, the hydraulic circuits 110 and 120 include the first hydraulic circuit 110 connected with the first hydraulic channel 40A and the second hydraulic circuit 120 connected with the second hydraulic channel 40B. The first and second hydraulic circuits 110 and 120 may be independently operated. More specifically, the first and second hydraulic circuits 110 and 120 respectively include a first pressure source 111 and a first flow control valve 112 and a second pressure source 121 and a second flow control valve 122. In this instance, a configuration of the second hydraulic circuit 120 may be substantially the same as a configuration of the first hydraulic circuit 110, and thus descriptions will be herein made focusing on the first hydraulic circuit 110 and repeated description of the second hydraulic circuit 120 will be omitted.

According to an embodiment of the present invention, the first and second hydraulic circuits 110 and 120 may store oil discharged from the master cylinder 20.

The first pressure source 111 of the first hydraulic circuit 110 stores oil, and a typically used accumulator may be used. The first flow control valve 112 is provided as a normally closed-type solenoid valve that remains normally closed and opened by the electronic control unit. For example, when the interval between the disk and the brake pad is increased, signals detected by a sensor (not shown) provided in the wheel brake 30 are output to the electronic control unit.

The first pressure source 111 of the first hydraulic circuit 110 may be connected with a flow passage for connecting the master cylinder 20 and the TC valve 47 by a first oil suction flow passage 113 so as to store a part of the oil discharged from the master cylinder 20. In addition, the outlet side of the first pressure source 111 is connected with the main flow passage 47a of the first hydraulic channel 40A by a first connection flow passage 114 so as to discharge the oil stored in the first pressure source 111. In this instance, a first flow control valve 112 is provided on the first connection flow passage 114. That is, as described above, the first flow control valve 112 remains normally closed and opened when performing a braking action in a case in which the interval between the disk and the brake pad provided in the wheel brake 30 is increased, and therefore a flow of the oil transmitted to the wheel brake 30 through the main flow passage 47a is increased to improve brake responsiveness even though the interval between the disk and the brake pad is increased.

Meanwhile, a first relief valve 115 may be provided on the first oil suction flow passage 113. The first relief valve 115 may prevent a reverse flow of the oil supplied to the first pressure source 111 through the first oil suction flow passage 113, and control a pressure.

The second hydraulic circuit 120 having the second pressure source 121 and the second flow control valve 122 may perform the same function as that of the above-described first hydraulic circuit 110. However, the second hydraulic circuit 120 is connected with the second hydraulic channel 40B so as to supply the oil stored in the second pressure source 121 to two wheels FL and RR controlled by the second hydraulic channel 40B. That is, as shown in FIG. 1, the second pressure source 121 may store a part of the oil discharged from the master cylinder 20 by the second oil suction flow passage 123, and discharge oil to the main flow passage 47a through the second connection flow passage 124 by the operation of the second flow control valve 122 to thereby increase a flow of the oil. Meanwhile, a second relief valve 125 is provided on the second oil suction flow passage 123.

As described above, the initial flow increasing module 100 having the first and second hydraulic circuits 110 and 120 receives the supply of oil from the master cylinder 20 and increases a flow of the oil when the interval between the disk and the brake pad is increased, but the present invention is not limited thereto, the flow of the oil may be increased by storing the oil discharged from the pump 44.

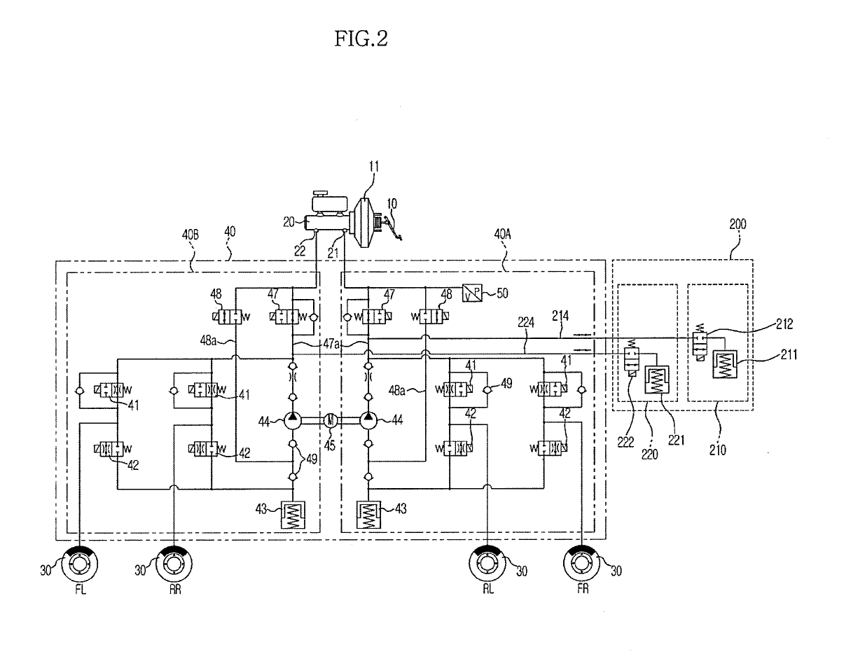

For example, in FIG. 2, a configuration of an initial flow increasing module provided in an electro-hydraulic brake system according to another preferred embodiment of the present invention is shown. Here, the same reference numerals as those in the above-described drawing refer to like elements having similar functions.

Referring to FIG. 2, an initial flow increasing module 200 according to the present embodiment includes first and second hydraulic circuits 210 and 220 respectively having pressure sources 211 and 221 and flow control valves 212 and 222, and each of the pressure sources 211 and 221 are respectively connected with the first hydraulic channel 40A and the second hydraulic channel 40B by a first connection flow passage 214 and a second connection flow passage 224. In this instance, a configuration of the second hydraulic circuit 220 may be substantially the same as a configuration of the first hydraulic circuit 210, and thus descriptions will be herein made focusing on the first hydraulic circuit 210 and repeated description of the second hydraulic circuit 220 will be omitted.

The first hydraulic circuit 210 may connect the main flow passage 47a and the first pressure source 211 through the first connection flow passage 214 so as to store oil discharged from the pump 44 in the first pressure source 211. In this instance, a first flow control valve 212 is provided on the first connection flow passage 214.

Here, the first flow control valve 212 is provided as a normally closed-type solenoid valve that remains normally closed and opened when oil is stored in the first pressure source 211, or opened when performing a braking action in a case in which the interval between the disk and the brake pad is increased. That is, the first flow control valve 212 may control a two-way flow of oil.

The second hydraulic circuit 220 having the second pressure source 221 and the second flow control valve 222 may perform the same functions as those of the first hydraulic circuit 210, and is connected with the main flow passage 47a of the second hydraulic channel 40B by the second connection flow passage 224.

Meanwhile, the initial flow increasing modules 100 and 200 according to the present invention may adopt and use any one of the embodiments described in FIGS. 1 and 2, but not limited thereto, and may use a combination of the embodiments. That is, referring to FIG. 1, the oil may be supplied from the master cylinder 20 through the first and second oil suction flow passages 113 and 123, or the oil discharged from the pump 44 through the first and second connection flow passages 114 and 124 may be stored.

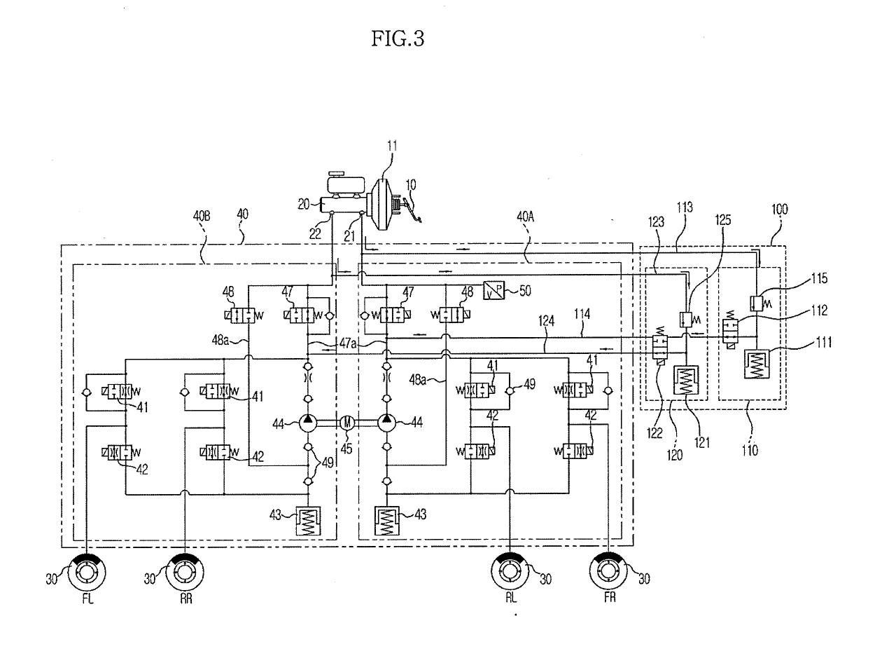

Next, an operating condition in which the oil discharged from the master cylinder 20 is stored to increase a flow of oil will be briefly described with reference to FIGS. 1 and 3.

First, when braking of a vehicle is normally operated, the oil discharged from the master cylinder 20 is stored in the first and second pressure sources 111 and 121. In this instance, the oil stored in each of the pressure sources 111 and 121 is maintained to be stored because the first and second flow control valves 112 and 122 are closed.

Thereafter, when the interval between the disk and the brake pad is increased by abrasion of the brake pad due to long-time use, the increased interval may be detected by a sensor (not shown) to open the first and second flow control valves 112 and 122, whereby the oil stored in the first and second pressure sources 111 and 121 is transmitted to the wheel brake 30. Accordingly, a flow of the oil transmitted to the wheel brake 30 is increased so as to compensate for delay of brake response due to the increased interval between the disk and the brake pad, thereby performing a stable braking action.

Meanwhile, each of the hydraulic circuits 110 and 120 of the initial flow increasing module 100 is independently used.

As described above, according to the embodiments of the present invention, the initial flow increasing module may store oil, and supply the stored oil to the wheel brake when braking in a case in which the interval between the disk and the brake pad is increased, thereby improving brake responsiveness. As a result, it is possible to improve a braking sense of a driver and prevent a braking distance from being increased.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An initial flow increasing module for reducing delay of brake responsiveness due to abrasion of a brake pad, which is connected with an electronic stability control (ESC) system having a first hydraulic channel and a second hydraulic channel each for controlling a liquid pressure transmitted to two wheels, the initial flow increasing module comprising:
a hydraulic circuit that includes a pressure source in which oil is stored so as to increase a braking initial flow and a flow control valve connected with the pressure source so as to control a flow of oil transmitted to a wheel brake provided in each wheel from the pressure source,
wherein the hydraulic circuit includes a first hydraulic circuit connected with the first hydraulic channel and a second hydraulic circuit connected with the second hydraulic channel, and the first and second hydraulic circuits respectively include a first pressure source and a first flow control valve and a second pressure source and a second flow control valve and are operated independently.

2. The initial flow increasing module according to claim 1, wherein:
the ESC includes the first hydraulic channel connected with a first port of a master cylinder for generating a pressure so as to control liquid pressure transmission to the wheel brake and the second hydraulic channel connected with a second port of the master cylinder to control liquid pressure transmission to the wheel brake;
the first and second hydraulic channels respectively include a plurality of NO-type solenoid valves and a plurality of NC-type solenoid valves which are provided in an upstream side and a downstream side of the wheel brake so as to control a flow of a braking oil pressure, a low pressure accumulator for temporarily storing oil discharged from the wheel brake, a pump for sucking and pumping the oil discharged from the wheel brake or oil from the master cylinder by drive of a motor, a TC valve provided on a main flow passage for connecting the master cylinder and an outlet of the pump, a shuttle valve provided on an auxiliary flow passage branched from the main flow passage so as to guide oil of the master cylinder to be sucked into an inlet of the pump, and an electronic control unit for controlling drive of the plurality of solenoid valves and the motor; and
the oil stored in each of the pressure sources of the first and second hydraulic circuits is formed so as to store the oil discharged from the master cylinder or the oil discharged from the pump.

3. The initial flow increasing module according to claim 2, wherein, when the oil discharged from the master cylinder is stored, the first hydraulic circuit includes a first oil suction flow passage connected so as to store the oil discharged from the master cylinder in the first pressure source and a first connection flow passage connected with the main flow passage so as to transmit the oil stored in the first pressure source to the wheel brake through the first flow control valve, and the second hydraulic circuit includes a second oil suction flow passage connected so as to store the oil discharged from the master cylinder in the second pressure source and a second connection flow passage connected with the main flow passage so as to transmit the oil stored in the second pressure source to the wheel brake through the second flow control valve.

4. The initial flow increasing module according to claim 3, wherein a relief valve is provided on each of the first and second oil suction flow passages.

5. The initial flow increasing module according to claim 3, wherein the first and second flow control valves are provided as a normally closed-type solenoid valve that remains normally closed and opened when braking action is performed in a case in which an interval between a disk and a brake pad which are provided in the wheel brake is increased.

6. The initial flow increasing module according to claim 2, wherein, when the oil discharged from the outlet of the pump is stored, the first hydraulic circuit includes a first connection flow passage connected with the first pressure source through the first flow control valve, and the second hydraulic circuit includes a second connection flow passage connected with the second pressure source through the second flow control valve.

7. The initial flow increasing module according to claim 6, wherein the first and second flow control valves are provided as a two-way normally closed-type solenoid valve that remains normally closed and opened when oil is stored in the first and second pressure sources or remains normally closed and opened when braking action is performed in a case in which an interval between a disk and a brake pad which are provided in the wheel brake is increased.
